(19) United States
(12) Patent Application Publication
(10) Pub. No.: US 2020/0080214 A1
(43) Pub. Date: Mar. 12, 2020

(54) COPPER FOIL AND MANUFACTURING METHOD THEREOF, AND CURRENT COLLECTOR OF ENERGY STORAGE DEVICE

(71) Applicant: Industrial Technology Research Institute, Hsinchu (TW)

(72) Inventors: Jhen-Rong Chen, Taoyuan City (TW); Chiu-Yen Chiu, Hsinchu County (TW)

(73) Assignee: Industrial Technology Research Institute, Hsinchu (TW)

(21) Appl. No.: 16/232,071

(22) Filed: Dec. 26, 2018

(30) Foreign Application Priority Data
Sep. 12, 2018 (TW) 107132133

(51) Int. Cl. C25D 1/04; C25D 1/20; C25D 3/38; H01M 4/66; H01M 4/75

(52) U.S. Cl. CPC C25D 1/04; C25D 1/20; H01M 4/75; H01M 4/661; C25D 3/38

(57) ABSTRACT

A copper foil and a manufacturing method of the same, and a current collector of an energy storage device are provided. The manufacturing method includes forming a copper foil by direct-current electroplating on a surface of a cathode and separating the copper foil from the cathode after the electroplating, wherein the structure of the copper foil includes columnar grains of a (111) orientation having a volume ratio of 70% or more. The conditions of the direct-current electroplating include performing at a range of 35° C. to 55° C. using a plating solution containing 40 g/L to 120 g/L of copper ions, 40 g/L to 110 g/L of sulfuric acid, and 30 ppm to 90 ppm of chloride ions at a current density between 20 ASD and 60 ASD.

### CROSS-REFERENCE TO RELATED APPLICATION

This application claims the priority benefits of Taiwan application serial no. 107132133, filed on Sep. 12, 2018. The disclosure of which is hereby incorporated by reference herein in its entirety.

### TECHNICAL FIELD

The disclosure relates to a copper foil.

### BACKGROUND

The major automakers are optimistic about the prospects of the electric vehicle market, and have accelerated the development of new electric vehicles. As a result, the demand for lithium batteries with higher energy density for the use of electric vehicle has increased significantly.

The copper foil for the negative electrode current collector in the new electric vehicle lithium battery needs to have high conductivity, and at the same time needs to withstand high process temperatures and the volume expansion and contraction caused by lithium ion intercalation and de-intercalation during charging and discharging. However, the tensile strength of the conventional copper foils is dramatically decayed at this temperature due to grain growth, and the high strength requirements of the lithium battery foil is not readily met.

Therefore, the development of a copper foil for the lithium battery for the use of electric vehicle may withstand high temperatures and is not susceptible to softening and cracking and has better conductivity is needed.

### SUMMARY

The manufacturing method of the copper foil of the disclosure includes the following steps. A copper foil is formed on the surface of a cathode by direct-current electroplating, wherein the structure of the copper foil includes columnar grains of a (111) orientation having a volume ratio of 70% or more. The cathode and the copper foil are then separated. The conditions of the direct-current electroplating include performing at a range of 35° C. to 55° C. using a plating solution containing 40 g/L to 120 g/L of copper ions, 40 g/L to 110 g/L of sulfuric acid, and 30 ppm to 90 ppm of chloride ions at a current density between 20 ASD and 60 ASD.

The copper foil of the disclosure is produced by the above manufacturing method, wherein each of the columnar grains of the (111) orientation of the copper foil is formed by stacking plate-shaped structures perpendicular to the grain boundary of the column grain.

The current collector of the energy storage device of the disclosure includes the above copper foil.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a step diagram of a manufacturing process of a copper foil according to an embodiment of the disclosure.

FIG. 2A is a focused ion beam (FIB) cross-section micrograph of the copper foil of the experimental example 3.

FIG. 2B is a FIB cross-section micrograph of the copper foil of the experimental example 3 after high-temperature annealing.

### DETAILED DESCRIPTION OF DISCLOSED EMBODIMENTS

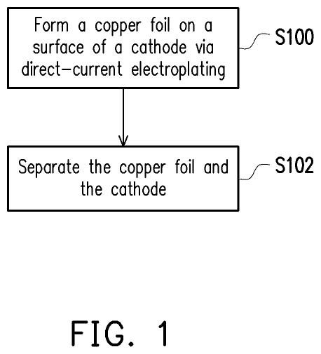

FIG. 1 is a step diagram of a manufacturing process of a copper foil according to an embodiment of the disclosure.

Referring to FIG. 1, the method of the present embodiment includes first performing step S100 to form a copper foil on the surface of a cathode by a direct-current electroplating, and the conditions of the direct-current electroplating include performing at a range of 35° C. to 55° C. using a plating solution containing 40 g/L to 120 g/L of copper ions, 40 g/L to 110 g/L of sulfuric acid, and 30 ppm to 90 ppm of chloride ions at a current density between 20 ASD and 60 ASD. The plating rate is about 8.8 μm/minute or more. In some embodiments, the electroplating temperature may be between 40° C. and 50° C., or the current density may be between 30 ASD and 60 ASD. If the electroplating temperature is too low or the current density is too small, the plating rate is too slow which does not meet the requirements of mass production of the copper foil industry (plating rate is equal to or greater than 8.8 μm/minute). In an embodiment, the cathode includes a titanium metal, titanium alloy, or stainless steel. In another embodiment, the cathode may also include a conductive substrate and a release layer formed on the surface of the conductive substrate, wherein the material of the release layer may be a metal oxide such as titanium oxide, nickel oxide, or chromium oxide; and the conductive substrate may be made of any conductive material such as acid-resistant titanium metal, titanium alloy, or stainless steel. The copper foil formed by the above method has a structure including columnar grains of a (111) orientation, and the volume ratio of the columnar grains of the (111) orientation in the structure may be 70% or more, such as 80% or more, or 85% or more. In some embodiments, the columnar grains of the (111) orientation in the structure of the copper foil formed by the above method account for at least 70% of the cross-sectional area of the copper foil.

The concentrations of the various components included in the plating solution may be adjusted according to the required thickness and process plating rate. For example, the copper concentration in the plating solution is in the range of about 40 g/L to 120 g/L, such as 60 g/L to 100 g/L; the concentration of sulfuric acid in the plating solution is in the range of about 40 g/L to 110 g/L, such as 80 g/L to 100 g/L; and the chlorine concentration in the plating solution is in the range of about 30 ppm to 90 ppm, such as 30 ppm to 50 ppm. Additives such as a brightener, a lattice modification agent, and the like may be included in the plating solution as needed. The concentration of the brightener may be below about 5 mL/L, such as in the range of 2 mL/L to 5 mL/L; and the concentration of the lattice modification agent may be in the range of about 5 mL/L to 40 mL/L, such as in the range of 10 mL/L to 40 mL/L. The components of the brightener may include, for example, a nitrogen-containing functional group compound, a sulfur-containing functional group compound, or a combination thereof. The components of the lattice modification agent may include, for example, gelatin, chloride ions, or a combination thereof.

In addition, before step S100 is performed, the cathode may be immersed in the plating solution for a predetermined time (such as 20 seconds to 50 seconds) before plating. In the immersion step, the additive may be pre-adsorbed on the surface of the cathode, thus providing better reproducibility to the microstructure of the copper foil produced by electroplating to improve the stability of the copper foil quality.

Then, in step S102, the cathode and the copper foil are separated. The manner of separation is mainly physical, such as stripping.

The copper foil manufactured according to the present embodiment is suitable for an energy storage device application, such as a copper foil substrate in a negative electrode current collector of a lithium battery. The columnar grains included in the structure of the copper foil are formed by stacking plate-shaped structures perpendicular to the grain boundaries of the columnar grains. In other words, each of the columnar grains is consisted of plate-shaped structures stacked perpendicular to the grain boundary of the columnar grain. In an embodiment, the length ratio of the major axis to the minor axis of the plate-shaped structure is about 2 to 40.

The copper foil manufactured according to the present embodiment has characteristics such as a surface roughness Rz (JIS) less than 2 μm and a conductivity higher than 90% IACS. The thickness of the copper foil may be adjusted according to the product requirements, for example, if the copper foil is used as the current collector of a battery, in an embodiment, the prepared copper foil has characteristics such as a surface roughness Rz (JIS) less than 2 μm, a thickness of 6 μm to 8 μm, and a conductivity higher than 90% IACS. In another embodiment, the resulting copper foil may have a thickness less than 20 μm.

It is experimentally proven that after the copper foil manufactured in the present embodiment is heat-treated at 350° C. for one hour, a change amount in the volume ratio of the columnar grains of the (111) orientation is less than 5%, and the tensile strength thereof is equal to or greater than 40 kgf/mm². This mechanical property meets the mechanical characteristic requirements of the current collector of the lithium battery for the use of electric vehicle.

A number of experimental examples are described below to verify the efficacy of the disclosure. However, the disclosure is not limited to the following content. The raw materials, amounts and ratios, and treatment details of the plating solution used, etc. may be suitably changed without exceeding the scope of the disclosure. Accordingly, restrictive interpretation should not be made to the disclosure based on the experiments described below.

### Experimental Example 1

First, a basic plating solution (sulfuric acid-sulfuric acid copper plating solution) was prepared, containing copper ions: 90 g/L, sulfuric acid: 45 g/L, and 30 ppm of chloride ions, and 10 mL/L of a lattice modification agent and 5 mL/L of a brightener were added as electroplating additives, wherein the lattice modification agent was a commercially-available lattice modification agent (manufacturer: CLC, product number ECD731), and the brightener was also a commercially-available brightener (manufacturer: CLC, product number GR891).

A (polished) titanium drum installed in a rotating electrode device was used as the cathode, the anode was an insoluble anode (DSA), and using a DC power supply, the cathode was first immersed in a plating solution for 40 seconds, and then a copper foil having a thickness of 8 μm was directly formed on the surface of the titanium drum by electroplating at a current density of 40 ASD, a plating solution temperature of 40° C., and an electrode rotation speed of 700 rpm. The plating rate was 8.8 μm/minute.

After the electroplating was completed, the copper foil was separated from the titanium drum and subjected to subsequent testing. The test results are shown in Table 1 below.

### Experimental Example 2

A basic plating solution (sulfuric acid-sulfuric acid copper plating solution) was prepared, containing copper ions: 90 g/L, sulfuric acid: 45 g/L, and 30 ppm of chloride ions, and 40 mL/L of the above lattice modification agent and 2 mL/L of the above brightener were added as electroplating additives.

The same plating device as experimental example 1 was used, and the cathode was first immersed in the plating solution for 40 seconds, and then a copper foil having a thickness of 8 μm was directly formed on the surface of the titanium drum at a current density of 40 ASD, a plating solution temperature of 40° C., and an electrode rotation speed of 700 rpm. The plating rate was 8.8 μm/minute.

After the electroplating was completed, the copper foil was separated from the titanium drum and subjected to subsequent testing. The test results are shown in Table 1 below.

### Experimental Example 3

A basic plating solution (sulfuric acid-sulfuric acid copper plating solution) was prepared, containing copper ions: 90 g/L, sulfuric acid: 45 g/L, and 30 ppm of chloride ions, and 40 mL/L of the above lattice modification agent and 5 mL/L of the above brightener were added as electroplating additives.

The same plating device as experimental example 1 was used, and the cathode was first immersed in the plating solution for 40 seconds, and then a copper foil having a thickness of 8 μm was directly formed on the surface of the titanium drum at a current density of 40 ASD, a plating solution temperature of 40° C., and an electrode rotation speed of 700 rpm. The plating rate was 8.8 μm/minute.

After the electroplating was completed, the copper foil was separated from the titanium drum and subjected to subsequent testing. The test results are shown in Table 1 below.

### Comparative Example

Subsequent testing was performed using a double shiny side copper foil having a thickness of 8 μm sold by Fukuda Metal Foil & Powder Co., Ltd. as a control. The test results are shown in Table 1 below.

### Experimental Example 4

The same electroplating process as experimental example 2 was used, and the only difference is that the cathode was placed in the plating solution and then directly electroplated without immersion, followed by subsequent testing. The test results are shown in Table 1 below.

[Analysis Method]

<Roughness>

The roughness (Rz) was measured by a contact roughness meter in accordance with JIS94 standard.

<Conductivity>

The conductivity (% IACS) was obtained by measuring the sheet resistance using a four-point probe and substituting the result into the copper foil thickness calculation (copper foil thickness was converted based on the weight in grams per meter square-g/m²).

<Hardness>

The hardness was measured on a Vickers hardness tester with a test load of 10 grams.

<Tensile Strength and Elongation>

The measurement of room temperature tensile strength (RTS) and room temperature elongation (REL) were as follows. The copper foils were kept for 24 hours or more after electroplating and then punched into a dumbbell shape (gauge length: 50 mm, gauge width: 3 mm) for testing. Moreover, the electroplated copper foils were heat-treated at 350° C. for one hour in a protective atmosphere, and then taken out after cooling, and were also punched into dumbbell-shaped specimens for testing to obtain the tensile strength (HTS) and elongation (HEL) after the high-temperature treatment.

<Elastic Modulus>

The room temperature elastic modulus (E_{R}) and the high-temperature elastic modulus (E_{H}) were calculated from the data curves obtained from the tensile test.

TABLE 1

| | | Rz | IACS | Hardness | RTS | HTS | REL | HEL | E_{R} | E_{H} |
|---|---|---|---|---|---|---|---|---|---|---|
| | | (μM) | (%) | (Hg) | (kgf/mm²) | | (%) | | (GPa) | |
| Experimental | 1 | 1.4 to 1.6 | 97.6 | 152.9 | 60.5 | 50.0 | 2.8 | 2.5 | 75.3 | 79.9 |
| example | 2 | 1.7 to 1.8 | 97.9 | 166.2 | 63.6 | 53.6 | 3.0 | 3.0 | 90.4 | 94.5 |
| | 3 | 1.87 | 96.4 | 205.7 | 63.4 | 49.8 | 3.0 | 2.7 | 95.6 | 86.4 |
| | 4 | 1.7 to 1.8 | — | — | 47.6 | 45.8 | 2.5 | 3.8 | — | — |

| | | | | | | | | | |
|---|---|---|---|---|---|---|---|---|---|
| Comparative | 1.0 | 96.5 | 33.6 | 35.3 | 26.0 | 3.0 | 5.8 | 67.6 | 43.3 |
| example | | | | | | | | | |

It may be concluded from Table 1 that experimental examples 1 to 3 may achieve the expected effect, a self-annealing phenomenon at room temperature did not occur to the tensile strengths thereof, the room temperature tensile strengths may be kept high at 60 kg/mm² to 63 kg/mm², and the conductivities thereof were good at 96% IACS or more; after annealing at 350° C. for one hour, the tensile strengths thereof were still at a level of 50 kgf/mm². The 8 μm double shiny side copper foil Fukuda product as a comparative example had a tensile strength of only 35.3 kgf/mm² at room temperature and an elongation of only 3%; after annealing at 350° C. for one hour, the tensile strength was reduced to 26 kgf/mm², and the elongation was increased to 5.8%. It shows that the high-temperature microstructure of the comparative example was softened due to grain growth from heat, and therefore the strength was reduced and the elongation was increased.

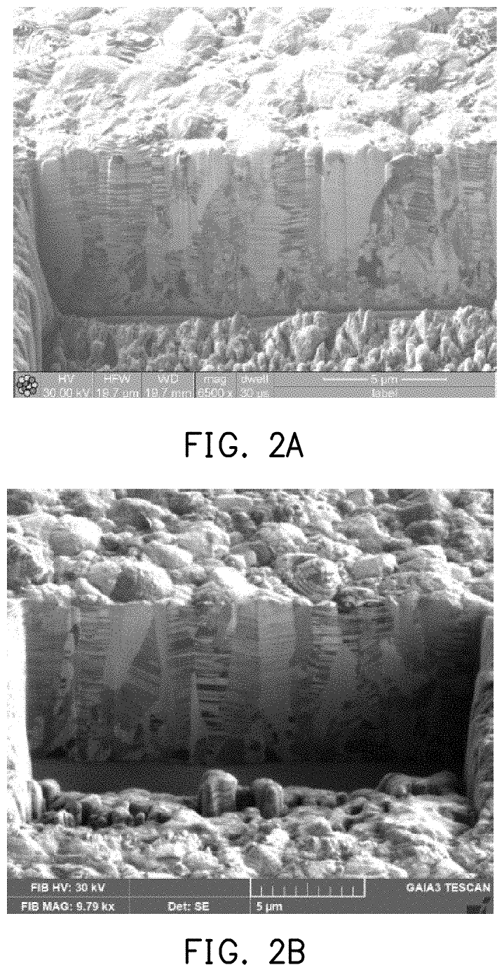

In addition, the copper foil of experimental example 3 was subjected to microstructure analysis by FIB (focusing ion beam)-SIM (scanning ion microscope) to obtain the FIB cross-section micrograph of FIG. 2A. Then, the copper foil of experimental example 3 was heat-treated at 350° C. for one hour under a protective atmosphere, and microstructure analysis was also performed after cooling to obtain the FIB cross-section micrograph of FIG. 2B. It may be observed from FIG. 2A and FIG. 2B that the cross-sectional microstructure of the copper foil after high-temperature annealing was still substantially a columnar grain structure of the (111) orientation.

In order to verify that the copper foil structures of all experimental examples before and after high-temperature annealing had a substantially columnar grain structure of the (111) orientation, the copper foils of experimental examples 1 to 3 were respectively subjected to X-ray diffraction (XRD) analysis. Then, the sum of the heights (intensity values) of all the peaks representing the different crystal orientations in the XRD analysis graph was the denominator, and the heights (intensity values) of the individual peaks representing the different crystal orientations were the numerators, and the volume ratios of different crystal orientations were calculated. The results are shown in Table 2 below.

Similarly, the copper foils of experimental examples 1 to 3 were annealed at a high temperature and cooled, and then subjected to XRD analysis, and the volume ratios of different crystal orientations were calculated in the above manner. The results are also shown in Table 2 below.

TABLE 2

| | | Volume ratio of | Volume ratio of | Volume ratio of |
|---|---|---|---|---|
| | | (111) | (200) | (220) |
| | | orientation | orientation | orientation |
| Experimental | Room temperature | 87.40% | 7.80% | 7.50% |
| example 1 | High-temperature | 88.60% | 6.20% | 5.20% |
| | annealing | | | |
| Experimental | Room temperature | 90% | 5.50% | 4.50% |
| example 2 | High-temperature | 91.10% | 4.60% | 4.30% |
| | annealing | | | |
| Experimental | Room temperature | 92.30% | 4.40% | 3.30% |
| example 3 | High-temperature | 92.30% | 4.60% | 3.10% |
| | annealing | | | |

It may be concluded from Table 2 that for all the copper foils annealed at 350° C. for one hour, the XRD analysis results thereof showed that the volume ratios of the columnar grains of the (111) orientation were all higher than 85%, and compared with the columnar grains of the (111) orientation before annealing, the change amount in volume ratio thereof was less than 5%.

Based on the above, the copper foil of the disclosure is manufactured under specific electroplating conditions, and thus has all of the characteristics of resistance to high temperature, not readily softened and cracked, and high conductivity. The copper foil manufactured by the disclosure is suitable for the current collector of an energy storage device due to the characteristic of resistance to high-temperature softening thereof.

It will be apparent to those skilled in the art that various modifications and variations may be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A manufacturing method of a copper foil, comprising:
forming a copper foil on a surface of a cathode by a direct-current electroplating, wherein a structure of the copper foil comprises columnar grains of a (111) orientation having a volume ratio of 70% or more; and
separating the cathode from the copper foil, wherein conditions of the direct-current electroplating comprise:
performing at a range of 35° C. to 55° C. using a plating solution containing 40 g/L to 120 g/L of copper ions, 40 g/L to 110 g/L of a sulfuric acid, and 30 ppm to 90 ppm of chloride ions at a current density between 20 ASD and 60 ASD.

2. The manufacturing method of the copper foil of claim 1, wherein the cathode comprises titanium metal, titanium alloy, or a stainless steel.

3. The manufacturing method of the copper foil of claim 1, wherein the cathode comprises a conductive substrate and a release layer formed on a surface of the conductive substrate.

4. The manufacturing method of the copper foil of claim 3, wherein a material of the release layer comprises titanium oxide, nickel oxide, or chromium oxide.

5. The manufacturing method of the copper foil of claim 1, wherein the plating solution further comprises a lattice modification agent and a brightener.

6. The manufacturing method of the copper foil of claim 1, further comprising, before the step of the direct-current electroplating, immersing the cathode in the plating solution for a predetermined time.

7. A copper foil manufactured by the manufacturing method of claim 1, wherein a structure of the copper foil comprises columnar grains of a (111) orientation having a volume ratio of 70% or more, and each of the columnar grains of the (111) orientation of the copper foil is consisted of plate-shaped structures stacked perpendicular to grain boundaries of the columnar grains.

8. The copper foil of claim 7, wherein after the copper foil is heat-treated at 350° C. for one hour, a change amount in the volume ratio of the columnar grains of the (111) orientation is less than 5%, and the copper foil has a tensile strength equal to or greater than 40 kgf/mm².

9. The copper foil of claim 7, wherein a length ratio of a major axis to a minor axis of the plate-shaped structure is 2 to 40.

10. The copper foil of claim 7, wherein the copper foil has a surface roughness Rz (JIS) less than 2 μm.

11. The copper foil of claim 7, wherein the copper foil has a thickness less than 20 μm.

12. The copper foil of claim 7, wherein the copper foil has a conductivity higher than 90% IACS.

13. A current collector of an energy storage device comprising the copper foil of claim 7.
